(19) United States
(12) Patent Application Publication
(10) Pub. No.: US 2021/0173038 A1
(43) Pub. Date: Jun. 10, 2021

(54) APPARATUS, SYSTEM AND METHOD OF TRACKING A RADIO BEACON

(71) Applicant: FATHOM SYSTEMS INC., Vancouver (CA)

(72) Inventor: AFZAL Muhammad Haris, Vancouver (CA)

(21) Appl. No.: 16/325,852

(22) PCT Filed: Aug. 16, 2017
(86) PCT No.: PCT/CA2017/050973

§ 371 Date: Feb. 15, 2019

Related U.S. Application Data
(60) Provisional application No. 62/376,641, filed on Aug. 18, 2016.

(51) Int. Cl. G01S 5/02; G01S 11/06; G01S 11/02

(52) U.S. Cl. CPC G01S 5/0294; G01S 11/026; G01S 11/06; G01S 5/0247

(57) ABSTRACT

A method of tracking a radio beacon includes receiving radio beacon signals at electronic hub devices having known locations. The electronic hub device including both omni-directional and multi-directional antennas receiving radio beacon signals from the radio beacon. Changes over time of the received signal strengths at the omni-directional and multi-directional antennas are analyzed to determine a direction gradient or a direction of travel of the radio beacon.

### TECHNICAL FIELD

The present disclosure relates to methods and apparatus for tracking radio beacons in weak Global Navigation Satellite System (GNSS) signal environments.

### BACKGROUND

In some environments, such as indoor or in areas where many natural or manufactured obstacles are present, for example, GNSS signal reception may be weak. In these environments, beacon tracking systems that rely on GNSS signals are generally inoperable.

Received signal strength is often used to estimate range of a radio beacon from multiple receivers, which may in turn be used to estimate the radio beacon's position. When obstacles are present between the radio beacon and the receivers, the radio beacon signals may be blocked or reflections may result such that a determined position is less reliable and less accurate. Tracking a radio beacon based on received signal strength does not generally produce accurate results due to signal fading, which is difficult to decorrelate from dynamics, multipath and Signal-to-Noise Ratio (SNR), for example.

In some environments, signal timing may be used for tracking a radio beacon, however, signal timing is not usable with third party hardware because timing synchronization between the beacon and the receiver is currently not achievable. As a result, applications of signal timing based location tracking are limited.

### SUMMARY

In an aspect of the present disclosure there is provided a method of determining direction information of a radio beacon from a starting location comprising: receiving radio beacon signals at an omni-directional antenna in communication with a radio sub-system of an electronic hub device over a first time period and over a second time period and determining a change in omni-directional received signal strength between the first time period and the second time period; receiving the radio beacon signals at a multi-directional antenna in communication with another radio sub-system of the electronic hub device over the first time period and over the second time period, determining changes in received signal strength for antenna directions of the multi-directional antenna between the first time period and the second time period; grouping ones of the changes in received signal strength of the multi-directional antenna into groups corresponding to adjacent antenna directions; determining the direction information of the radio beacon based on inputs, the inputs comprising: the change in omni-directional received signal strength and the pairs of changes in received signal strength of the multi-directional antenna; wherein the starting location of the radio beacon and a location of the first electronic hub device are known.

In another aspect of the present disclosure there is provided a method of determining direction information of a radio beacon from a starting location using multiple electronic hub devices comprising: receiving radio beacon signals at omni-directional antennas of the multiple electronic hub devices over a first time period and over a second time period and determining changes in omni-directional received signal strength between the first time period and the second time period for the multiple electronic hub devices; receiving the radio beacon signals at multi-directional antennas of the multiple electronic hub devices over the first time period and over the second time period and determining changes in received signal strength for antenna directions of the multi-directional antennas between the first time period and the second time period; grouping ones of the changes in received signal strength of the multi-directional antennas into groups corresponding to adjacent antenna directions for ones of the electronic hub devices; determining the direction information of the radio beacon based on inputs, the inputs comprising: the changes in omni-directional received signal strength for the of the multiple electronic hub devices and the groups of changes in received signal strength for the multi-directional antenna for the multiple electronic hub devices; wherein the starting location of the radio beacon and locations of the multiple electronic hub devices are known.

In another aspect of the present disclosure there is provided a beacon tracking system comprising: a radio beacon movable from a known starting location, the radio beacon generating radio beacon signals; a first electronic hub device comprising: a first processor and a first radio sub-system in communication with a first omni-directional antenna and a first multi-directional antenna, the first omni-directional antenna receiving the radio beacon signals at a first received signal strength and the first multi-directional antenna receiving the radio beacon signals at first received signal strengths for antenna directions of the multi-directional antennas over a first time period and a second time period, the first electronic hub device comprising a first known location; a second electronic hub device comprising: a second processor and a second radio sub-system in communication with a second omni-directional antenna and a second multi-directional antenna, the second omni-directional antenna receiving the radio beacon signals at a second received signal strength and the second multi-directional antenna receiving the radio beacon signals at second received signal strengths for the antenna directions of the multi-directional antenna over the first time period and the second time period, the second electronic hub device comprising a second known location; wherein direction information of the radio beacon is determined based on inputs, the inputs comprising: changes in received signal strength for the first and second omni-directional antennas and changes in received signal strengths for adjacent antenna direction groups for the first and second multi-directional antennas.

In still another aspect of the present disclosure there is provided a method of tracking a radio beacon from a starting location comprising: receiving radio beacon signals at a first omni-directional antenna of a first electronic hub device and a second omni-directional antenna of a second electronic hub device over a time period; determining a travel gradient or a direction of travel of the radio beacon from the starting location based on a first received signal strength at the first electronic hub device and a second received signal strength at the second electronic hub device over the time period; wherein the starting location of the radio beacon and locations of the first electronic hub device and the second electronic hub device are known.

### DRAWINGS

The following figures set forth examples in which like reference numerals denote like parts. The present disclosure is not limited to the examples illustrated in the accompanying figures.

FIG. 1 is a schematic diagram of electronic hub devices and radio beacons of a radio beacon tracking system according to an example.

FIG. 2 is a schematic diagram of an electronic hub device according to an example.

FIG. 3 is a schematic diagram of an electronic hub device according to another example.

FIG. 4A depicts a radio beacon signal reception schedule at the electronic hub device of FIG. 2.

FIG. 4B depicts a radio beacon signal reception schedule at the electronic hub device of FIG. 3.

FIG. 4C depicts another example radio beacon signal reception schedule.

FIG. 5 is a schematic diagram of a deployed beacon tracking system according to an example.

FIG. 6 is a flowchart depicting a method of tracking a radio beacon according to an example.

FIG. 7 is a schematic diagram depicting a radio beacon moving relative to an electronic hub device.

FIG. 8A is a graph depicting received signal strength at the omni-directional antenna of the electronic hub device of FIG. 2 over a first time period.

FIG. 8B is a graph depicting received signal strength at the omni-directional antenna of the electronic hub device of FIG. 2 over a second time period.

FIG. 9A is a graph depicting received signal strength at antenna directions of the multi-directional antenna of the electronic hub device of FIG. 2 over the first time period.

FIG. 9B is a graph depicting received signal strength at antenna directions of the multi-directional antenna of the electronic hub device of FIG. 2 over the second time period.

FIG. 10 is a schematic diagram depicting possible direction outcomes combined to determine direction information of a radio beacon.

FIG. 11 shows graphs depicting fuzzy input according to first rules for determining direction information of a radio beacon.

FIG. 12 is a graph depicting output of the first rules.

FIG. 13 shows graphs depicting fuzzy input according to second rules for determining direction information of a radio beacon.

FIG. 14 is a graph depicting output of the second rules.

FIG. 15 is a flowchart depicting a method of tracking a radio beacon according to another example.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. Unless explicitly stated, the methods described herein are not constrained to a particular order or sequence. Additionally, some of the described methods or elements thereof can occur or be performed at the same point in time. In other instances, well-known methods, procedures and components have not been described in detail so as not to obscure the examples described herein. Also, the description is not to be considered as limiting the scope of the examples described herein.

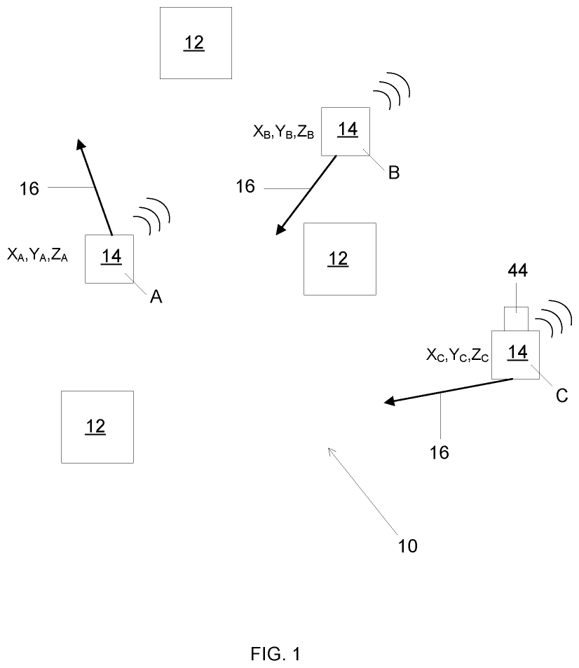

Referring to FIG. 1, an example beacon tracking system 10 including three electronic hub devices 12 and three radio beacons 14 is shown. When performing methods of tracking radio beacons as described herein, the electronic hub devices 12 determine direction gradients 16 of the radio beacons 14.

Tracking a radio beacon 14 includes updating the position of the radio beacon 14 at a relatively fast update rate in order to observe the motion and generate a traversed trajectory of the radio beacon 14. The radio beacon tracking system 10 may be used for asset tracking and analytics to discover movement patterns for marketing purposes, for example.

The radio beacon tracking system 10 is operable in any deployment environment including outdoors, indoors and in environments in which GNSS signal reception is weak, such as in dense urban environments, for example. The radio beacon tracking system 10 has particular advantages when the radio beacons 14 of the system 10 do not have GNSS location capability. Some examples of deployment environments of the radio beacon tracking system 10 include: office structures, retail structures, hospitals, hotels, points of interest, such as tourist attractions, for example, industrial and manufacturing structures, educational campuses, cargo handling ports and resource extraction locations, for example.

The radio beacon tracking system 10 of FIG. 1 is shown as an example. The radio beacon tracking system 10 may include any number of electronic hub devices 12 and radio beacons 14. Some deployments may include two electronic hub devices 12 and a single radio beacon 14, a few electronic hub devices 12 and tens of radio beacons 14, tens of electronic hub devices 12 and hundreds of radio beacons 14 or even larger deployments. The number of radio beacons 14 per pair of electronic hub devices 12 is not fixed and may be determined based on the deployment environment. The radio beacon tracking system 10 is operable with any type of radio signal, such as BLE (Bluetooth™ Low Energy), Bluetooth™, FM, AM, WiFi, Digital TV, ZigBee or 6LoWPan, for example. The radio beacons 14 may be any type of electronic device capable of generating a radio signal including Smartphones, tablets, laptop computers, fitness trackers and other wearable devices and specialized personnel tracking systems, for example. Example radio beacons 14 that may be used with the radio beacon location system 10 include BLE radio beacons manufactured by LSR, Estimote and BlueSense and Fathom, for example.

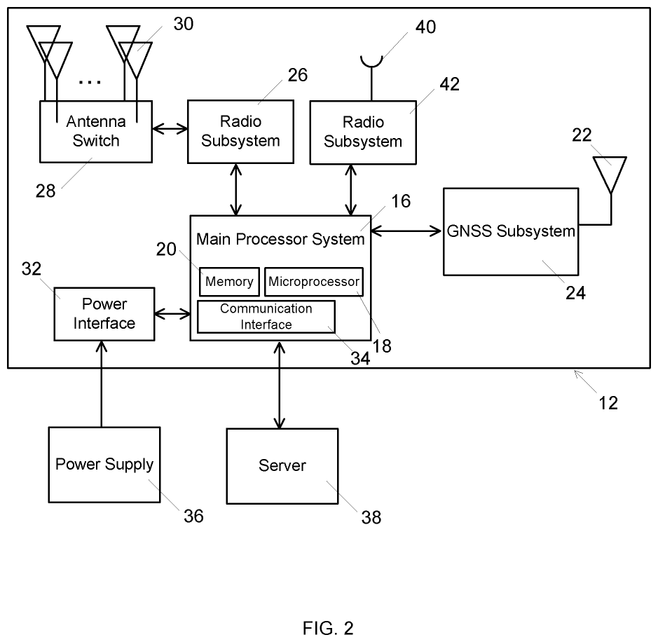

Referring also to FIG. 2, the electronic hub device 12 includes a main processor sub-system 16. The main processor sub-system 16 controls overall operation of the electronic hub device 12. The main processor sub-system 16 includes a microprocessor 18, a memory 20 and a communication interface 34. The communication interface 34 enables communication with a server 38 via a wireless or a wired connection. The server 38 may be a single server or a group of servers in communication with one another. An example of a main processor sub-system 16 is a Single Board Computer (SBC) with an Operating System (OS).

The electronic hub device 12 further includes a GNSS antenna 22 to receive GNSS signals and a GNSS sub-system 24 in communication with the main processor sub-system 16 and the GNSS antenna 22. The GNSS sub-system 24 generates digitized GNSS data corresponding to the GNSS signals for further processing by the main processor sub-system 16. Examples of a GNSS sub-system 24 include: a standalone GNSS receiver capable of generating a location estimate locally, an Assisted GNSS (A-GNSS) receiver that receives assistance data from another device to provide a location estimate, a Radio Frequency (RF) Front End (FE) in association with a Software Defined Radio (SDR) receiver at the electronic hub device 12 or distributed over one or more servers.

The electronic hub device 12 is capable of determining its location using the digitized GNSS data. In environments in which the signals from the GNSS satellites are weak, the electronic hub device 12 may communicate with the server 38 to process the digitized GNSS data over time. Depending on the strength of GNSS signals received, self-location may be immediate or may take hours or days, for example. As such, the electronic hub device 12 may self-locate by determining its location locally or by communicating with the server to determine its location. The electronic hub device 12 may alternatively determine its location using another method, such as using other networking structures located nearby such as Cell-ID and WiFi, for example. Alternatively, the electronic hub device 12 may retrieve information from the memory 20 that was stored at the time the electronic hub device 12 was deployed. In general, the location of the electronic hub device 12 is known and is used to determine locations of the radio beacons 14 in the methods described herein.

Radio sub-system 26 receives radio beacon signals from the radio beacons 14 via an antenna 30 and generates digitized data representing received signal strengths of the radio beacon signals received at the electronic hub device 12 at multiple orientations. The radio sub-system 26 communicates with the main processor sub-system 16 of the electronic hub device 12 and an antenna switch 28. The antenna switch 28 controls the antenna 30 of the electronic hub device 12. Radio sub-system 26 also functions as a transmitter to transmit radio beacon signals so that other electronic hub devices 12 may locate the electronic hub device 12. The electronic hub device 12 is also capable of transmitting the digitized data for receipt at another electronic hub device 12. In an example, the radio sub-system 26 is a standalone receiver of radio signals such as BLE, WiFi, FM, AM, Bluetooth™ and Digital TV, for example, that is capable of down-converting, demodulating and decoding information transmitted by radio beacons 14. In this example, the standalone receiver may be realized using discrete components or using minimum hardware such as SDRs (Software Defined Radios).

The antenna 30 may be a single mechanically steered directional antenna or may include multiple directional antennas, as shown in FIG. 2. When the antenna 30 includes multiple directional antennas, any number of antennas that fit within the physical limitations of the radio beacon 14 may be included. In an example in which multiple directional antennas are included, the antenna switch 28 may be operated to select a subset of the multiple directional antennas to receive the radio beacon signals from the radio beacons 14. A single antenna or a set of antennas may be selected at a time to receive beacon signals from one direction or a set of directions, respectively. In an example, the electronic hub devices 12 include six directional antennas.

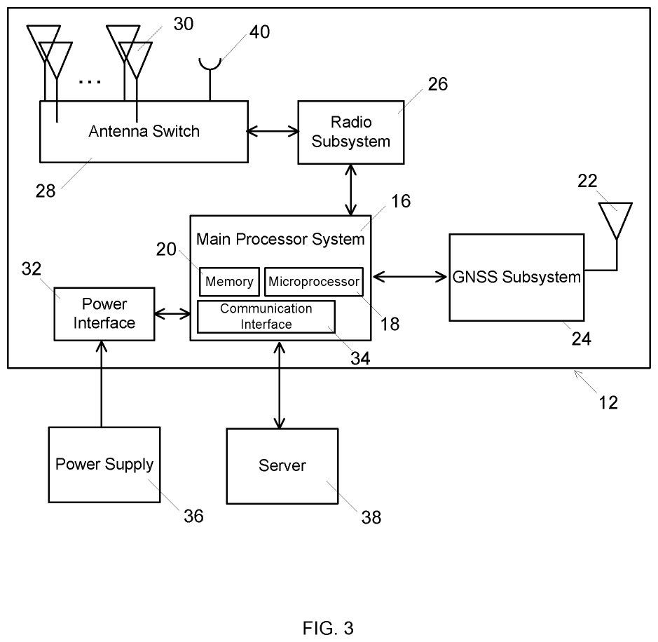

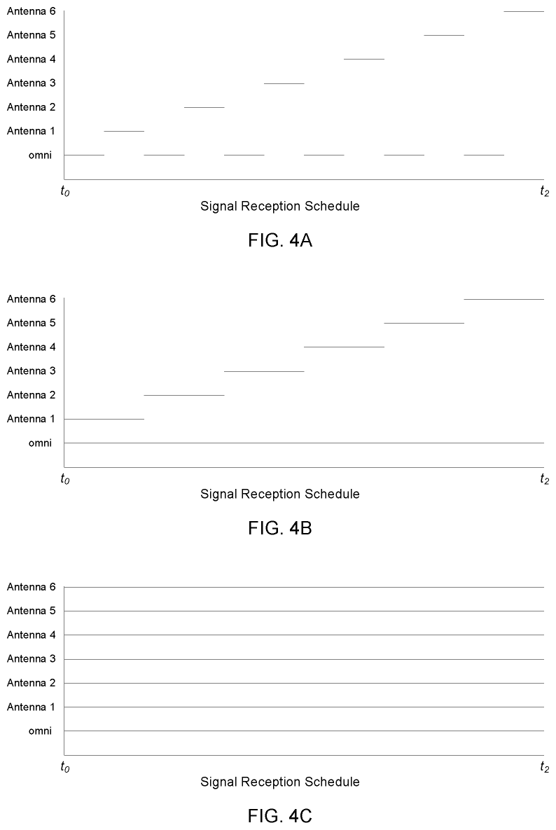

The electronic hub device 12 further includes an omni-directional antenna 40 in communication with a separate radio sub-system 42 to enable the antenna 30 and the omni-directional antenna 40 to receive radio beacon signals at the same time. In another example, which is shown in FIG. 3, the electronic hub device 12 includes a single radio sub-system 26 and the omni-directional antenna 40 is in communication with the antenna switch 28 such that the antenna switch 28 may select the omni-directional antenna 40 between selections of different directions of antenna 30 in order to obtain information regarding radio beacon signals all around the electronic hub device 12. In another example, the antenna 30 communicates with multiple radio sub-systems associated with multiple directional antennas thereof. Example signal reception schedules for the dual radio sub-system, the single radio sub-system and multiple radio sub-system examples are shown in FIGS. 4A, 4B and 4C, respectively. As shown, the more radio sub-systems that are included in the electronic hub device 12, the greater the amount of signal information that may be collected.

The electronic hub device 12 is powered by a power supply 36, which communicates with the main processor sub-system 16 via a power interface 32. In an example, the power supply 36 is one or more batteries. In another example, the power supply 36 is an electrical outlet.

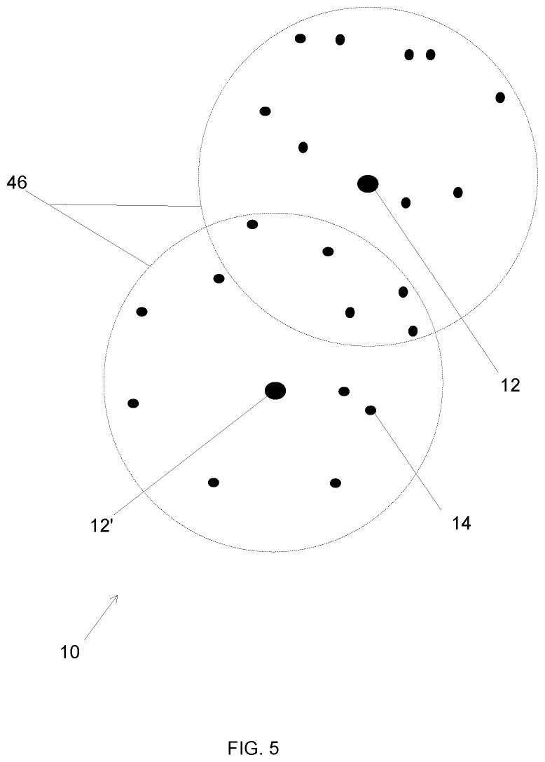

The radio beacon 14 may be any type of radio signal transmitting device. All of the radio beacons 14 of the beacon location system 10 may be the same type of device, or alternatively, one or more of the radio beacons 14 may be a different type of device. Referring back to FIG. 1, the radio beacons are identified as radio beacon A, radio beacon B and radio beacon C for the purpose of this description. Locations of the radio beacons 14 are (X_{A}, Y_{A}, Z_{A}), (X_{B}, Y_{B}, Z_{B}) and (X_{C}, Y_{C}, Z_{C}), respectively. Referring to FIG. 5, coverage areas 46 over which the electronic hub devices 12 and 12′ are able to receive radio beacon signals from the radio beacons 14 are shown. According to the methods described herein, the radio beacons 14 that are within the coverage areas of one or both electronic hub devices 12 and 12′ may be tracked. In the example of FIG. 5, additional electronic hub devices 12 may be deployed so that more of the radio beacons 14 are within the coverage areas of at least one other electronic hub devices 12 to improve tracking accuracy.

After starting locations of the radio beacons 14 have been determined, a method of tracking radio beacons 14 of a beacon tracking system 10 in a deployment environment may be performed. The starting locations may be determined by: 1) determining a distance based on received signal strength of radio beacon signals at the electronic hub device 12 and another device in communication with and having a known location relative to the electronic hub device 12; 2) determining an angle of arrival of radio beacon signals at the electronic hub device 12 and at another device in communication with and having a known location and orientation relative the electronic hub device 12; or 3) determining a distance based on received signal strength of radio beacon signals at the electronic hub device 12 and determining an angle of arrival of radio beacon signals at the electronic hub device 12. The starting locations of the radio beacons 14 may alternatively be determined by another location determination method.

Tracking of a radio beacon 14 includes determining direction information of the radio beacon 14 over two or more time periods. The direction information may be a direction gradient, which includes speed information, or may be a direction of travel.

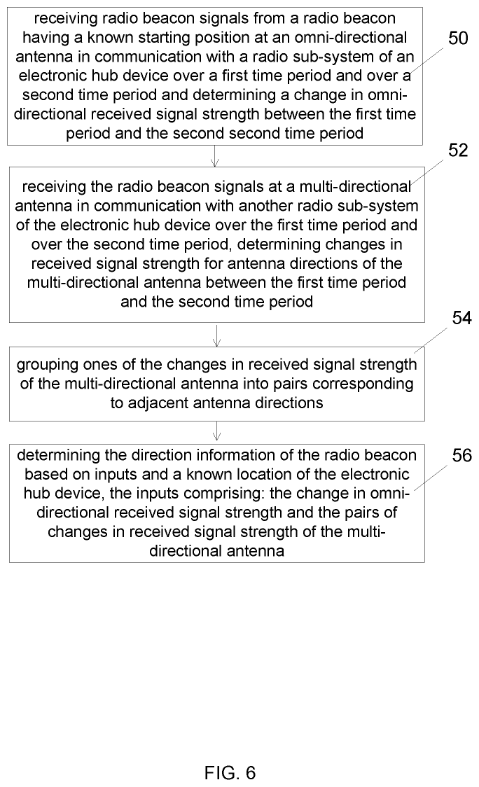

As shown in FIG. 6, a method of tracking a radio beacon 14 includes: at 50, receiving radio beacon signals from a radio beacon having a known starting position at an omni-directional antenna 40 in communication with a radio sub-system 42 of an electronic hub device 12 over a first time period and over a second time period and determining a change in omni-directional received signal strength (ΔRSSₒₘₙᵢ) between the first time period and the second time period, at 52, receiving the radio beacon signals at a multi-directional antenna 30 in communication with another radio sub-system 26 of the electronic hub device 12 over the first time period and over the second time period, determining changes in received signal strength for n antenna directions of the multi-directional antenna (ΔRSS_{multi_1} . . . ΔRSS_{multi_n}) between the first time period and the second time period, at 54, grouping ones of the changes in received signal strength for the antenna directions of the multi-directional antenna 30 into groups, such as pairs, for example, corresponding to adjacent antenna directions (such as directly adjacent antenna directions: ΔRSS_{multi_n} and ΔRSS_{multi_n+1}, ΔRSS_{multi_n+1} and ΔRSS_{multi_n+2} . . . ) at 56, determining the direction information of the radio beacon 14 based on inputs and a known location of the electronic hub device 12, the inputs comprising: the change in omni-directional received signal strength and the pairs of changes in received signal strength for the antenna directions of the multi-directional antenna 30. According to an example, instead of directly adjacent antenna directions, approximately adjacent antenna directions may be used, such as: ΔRSS_{multi_n} and ΔRSS_{multi_n+2}, ΔRSS_{multi_n+1} and ΔRSS_{multi_n+3}, for example. In addition, groups of three or more antenna directions may be used. In general, group size and arrangements of antenna directions may be selected depending on the radio beacon signal reception schedule and scan rate of the multi-directional antenna 20.

According to an example, the direction information is determined by combining at least some of the inputs according to a relationship between the inputs and possible direction outcomes and then combining the possible direction outcomes. The possible direction outcomes include: moving toward or away from one of the antenna directions of the multi-directional antenna 30 of the electronic hub device 12, moving toward or away from between one of the pairs of adjacent antenna directions of the multi-directional antenna 30 of the electronic hub device 12, moving away from or in front of one of the antenna directions of the multi-directional antenna 30 (i.e. perpendicular to antenna direction) and no change relative to the electronic hub device 12.

According to an example, the at least some of the inputs are combined by assigning weights to the inputs and then combining the inputs based on rules to determine the possible direction outcomes. The relationship between the inputs and the direction information may be implemented in fuzzy logic, for example.

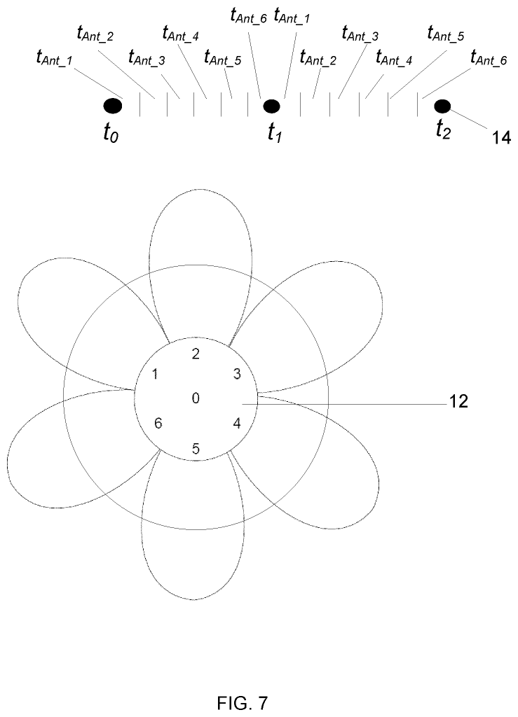

Referring to FIG. 7, an example of a radio beacon 14 that is tracked by an electronic hub device 12 according to the method of FIG. 6 is shown. Both a starting location of the radio beacon 14 and a location of the electronic hub device 12 are known. The electronic hub device 12 comprises a multi-directional antenna 30 having six individual antennas represented as 1, 2, 3, 4, 5, and 6 and an omni-directional antenna 40 represented by 0. The antennas of the multi-directional antenna 30 are located such that the individual antennas are able to scan about the entire circumference of the electronic hub device 12, as shown. In the example of FIG. 7, a radio beacon 14 travels in a direction that is tangent to the electronic hub device 12.

Operation of the method of tracking a radio beacon of FIG. 6 will now be described with reference to FIG. 7. At 50, the omni-directional antenna 40 of the electronic hub device 12 receives radio beacon signals from the radio beacon 14 over a first time period, t₀ to t₁, and over a second time period, t₁ to t₂, and a change in omni-directional received signal strength is determined as follows:

ΔRSSₒₘₙᵢ=RSS_{omni_time_period_2}−RSS_{omni_time_period_1}

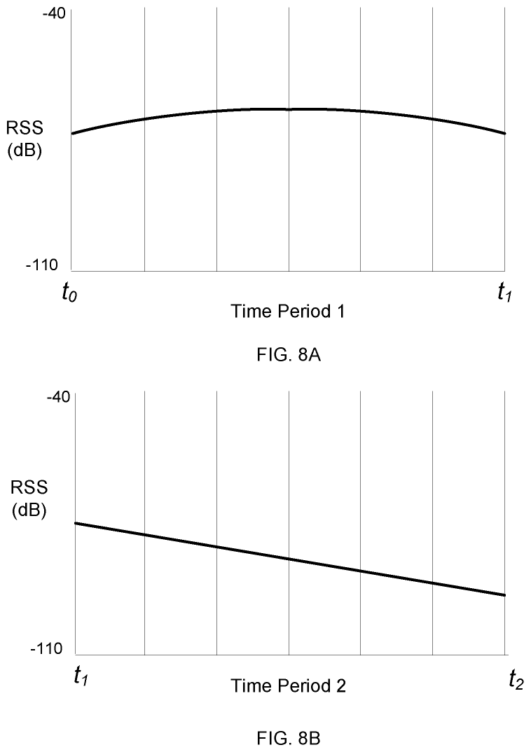

Example received signal strengths for time period 1 and time period 2 for the omni-directional antenna 40 are plotted in FIGS. 8A and 8B, respectively. According to FIGS. 8A and 8B, the RSS_{omni_time_period_1}=−75 dB and the RSS_{omni_time_period_2}=−70 dB. Therefore, ΔRSSₒₘₙᵢ=5 dB. The RSS is averaged over the time period in order to reduce noise.

At 52, the multi-directional antenna 30 of the electronic hub device 12 receives radio beacon signals from the radio beacon 14 over the first time period, t₀ to t₁, and over the second time period, t₁ to t₂, and determines changes in received signal strength for six antenna directions of the multi-directional antenna 30 as follows:

ΔRSS_{multi_1}=RSS_{multi_1_time_period_2}−RSS_{multi_1_time_period_1}

ΔRSS_{multi_2}=RSS_{multi_2_time_period_2}−RSS_{multi_2_time_period_1}

ΔRSS_{multi_3}=RSS_{multi_3_time_period_2}−RSS_{multi_3_time_period_1}

ΔRSS_{multi_4}=RSS_{multi_4_time_period_2}−RSS_{multi_4_time_period_1}

ΔRSS_{multi_5}=RSS_{multi_5_time_period_2}−RSS_{multi_5_time_period_1}

ΔRSS_{multi_6}=RSS_{multi_6_time_period_2}−RSS_{multi_6_time_period_1}

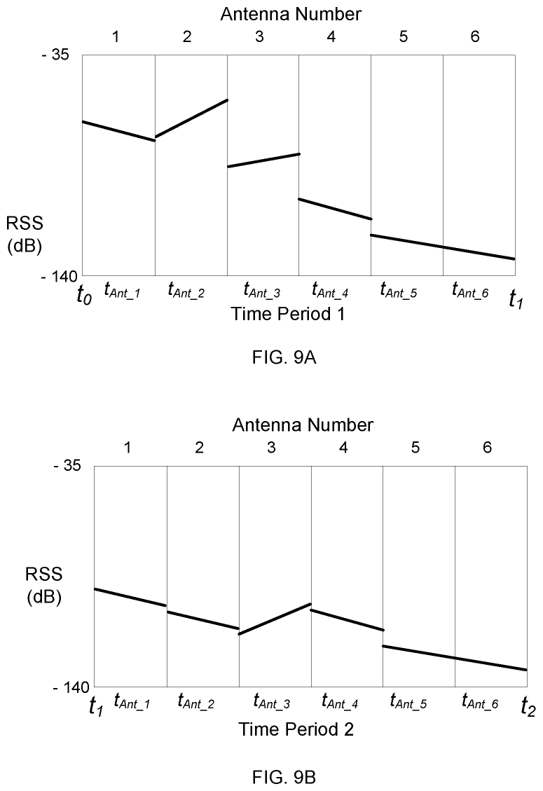

Example received signal strengths for time period 1 and time period 2 for the six antennas of the multi-directional antenna 40 are plotted in FIGS. 9A and 9B, respectively. According to FIGS. 9A and 9B, ΔRSS_{multi_1}=7 dB, ΔRSS_{multi_2}=55 dB, ΔRSS_{multi_3}=5 dB, ΔRSS_{multi_4}=14 dB, ΔRSS_{multi_5}=0 dB and ΔRSS_{multi_6}=0 dB.

At 54, the changes in received signal strength for the antenna directions of the multi-directional antenna 30 are grouped into pairs corresponding to adjacent antenna directions as follows: ΔRSS_{multi_1} and ΔRSS_{multi_2}, ΔRSS_{multi_2} and ΔRSS_{multi_3}, ΔRSS_{multi_3} and ΔRSS_{multi_4}, ΔRSS_{multi_4} and ΔRSS_{multi_5}, ΔRSS_{multi_5} and ΔRSS_{multi_6}, and ΔRSS_{multi_6} and ΔRSS_{multi_1}.

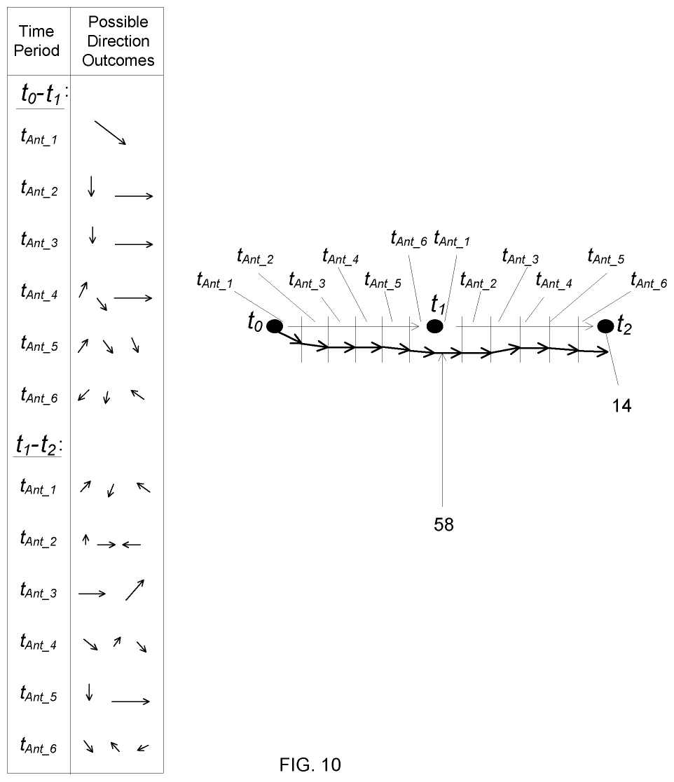

At 56, the direction information of the radio beacon 14 is determined based on the change in omni-directional received signal strength and the pairs of changes in received signal strength for the antenna directions of the multi-directional antenna 30. Relationships between the inputs: ΔRSSₒₘₙᵢ, ΔRSS_{multi_1} and ΔRSS_{multi_2}, ΔRSS_{multi_2} and ΔRSS_{multi_3}, ΔRSS_{multi_3} and ΔRSS_{multi_4}, ΔRSS_{multi_4} and ΔRSS_{multi_5}, ΔRSS_{multi_5} and ΔRSS_{multi_6}, and ΔRSS_{multi_6} and ΔRSS_{multi_1} and the direction information may be understood with reference to FIG. 10 in which the direction information is shown as a plurality of arrows 58. The arrows 58 are the vector sums of the possible direction outcome arrows in the adjacent table. The possible direction outcome arrows are based on the change in received signal strength from the omni-directional antenna 40 and pairs of changes in received signal strength of adjacent antenna directions of the multi-directional antenna 30.

According to another example, determination of the direction information may be implemented in fuzzy logic based on a rule set. First rules of the rule set are based on the change in omni-directional received signal strength and the changes in received signal strength of each of the multi-directional antenna directions and second rules of the rule set are based on the change in omni-directional received signal strength and the changes in received signal strength of each of the multi-directional antenna direction pairs.

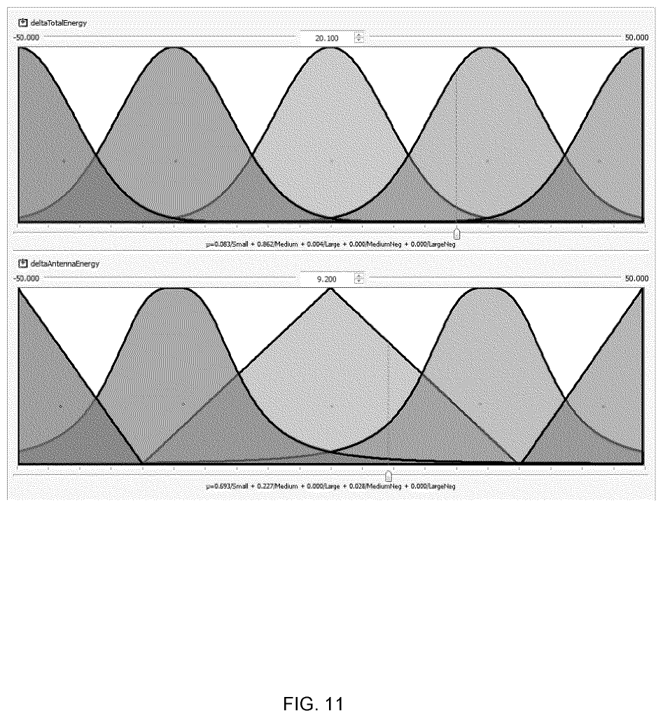

FIG. 11 represents the fuzzy sets associated with the inputs for first rules. According to the example, five fuzzy sets are defined for the inputs. The weights corresponding to the fuzzy sets are: small, positive (+ve) medium, negative (−ve) medium, positive (+ve) large and negative (−ve) large. The fuzzy sets have Gaussian distributions for the ΔRSS of the omni-directional antenna 40 and a combination of Gaussian and linear distributions for the ΔRSS of the antenna directions of the multi-directional antenna 30, as shown in FIG. 11.

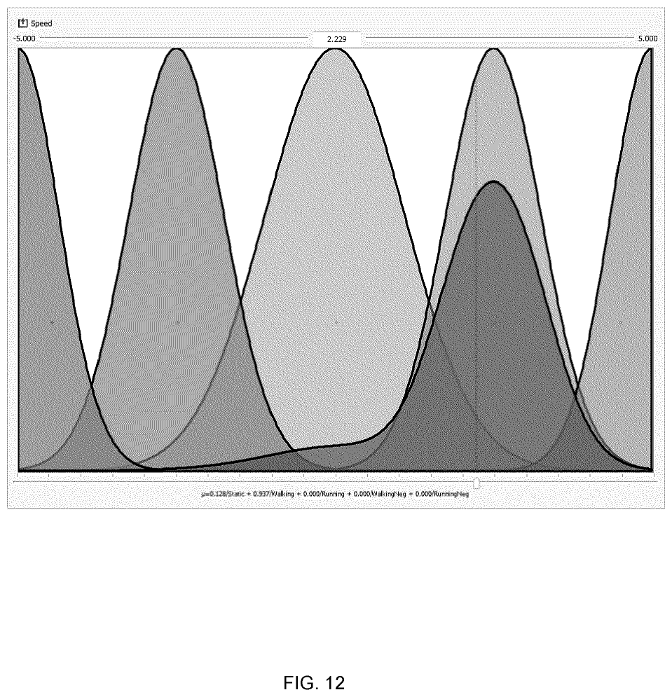

FIG. 12 represents the fuzzy sets associated with the outputs of the first rules. According to the example, five fuzzy sets are defined for the outputs. The fuzzy sets correspond to: static, positive (+ve) walking, (−ve) negative walking, positive (+ve) running and (−ve) negative running. The fuzzy sets have Gaussian distributions, as shown in FIG. 12.

Example first rules include:

If ΔRSSₒₘₙᵢ is small and ΔRSS_{multi_n} is −ve medium then speed=−ve walking.
If ΔRSSₒₘₙᵢ is +ve medium and ΔRSS_{multi_n} is small then speed=+ve walking.
If ΔRSSₒₘₙᵢ is +ve medium and ΔRSS_{multi_n} is +ve medium then speed=+ve walking.
If ΔRSSₒₘₙᵢ is +ve medium and ΔRSS_{multi_n} is +ve large then speed=+ve running.
If ΔRSSₒₘₙᵢ is +ve large and ΔRSS_{multi_n} is +ve medium then speed=+ve running.
If ΔRSSₒₘₙᵢ is +ve large and ΔRSS_{multi_n} is +ve large then speed=+ve running.
If ΔRSSₒₘₙᵢ is −ve medium and ΔRSS_{multi_n} is small then speed=−ve walking.
If ΔRSSₒₘₙᵢ is −ve medium and ΔRSS_{multi_n} is −ve medium then speed=−ve walking.
If ΔRSSₒₘₙᵢ is −ve medium and ΔRSS_{multi_n} is −ve large then speed=−ve running.
If ΔRSSₒₘₙᵢ is −ve large and ΔRSS_{multi_n} is −ve medium then speed=−ve running.
If ΔRSSₒₘₙᵢ is −ve large and ΔRSS_{multi_n} is −ve large then speed=−ve running.

As shown, the inputs are ΔRSSₒₘₙᵢ=20.100 dB and ΔRSS_{multi_1}=9.200 dB and the output is 2.29 m/s after defuzzification. The defuzzification method used is centroid defuzzification, however, other methods of defuzzification, such as centre of mass or majority rule, for example, may alternatively be used.

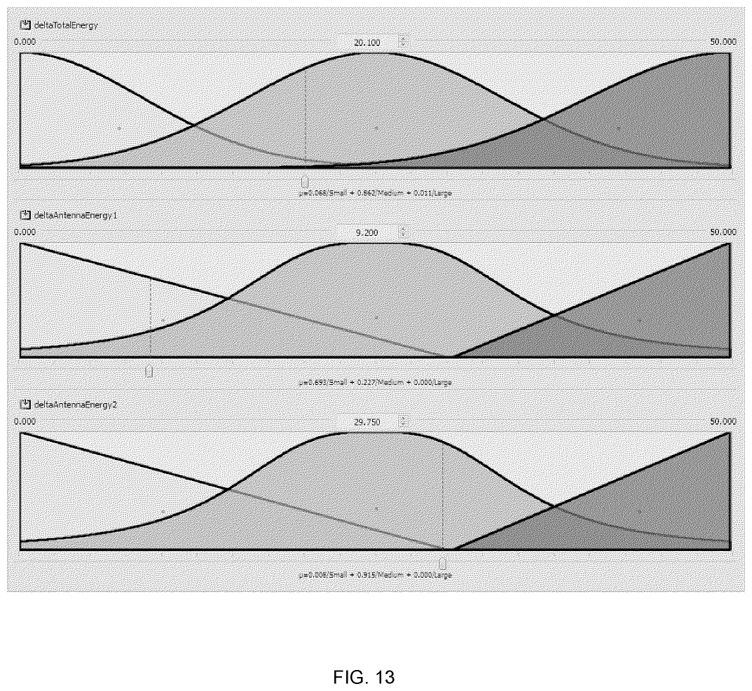

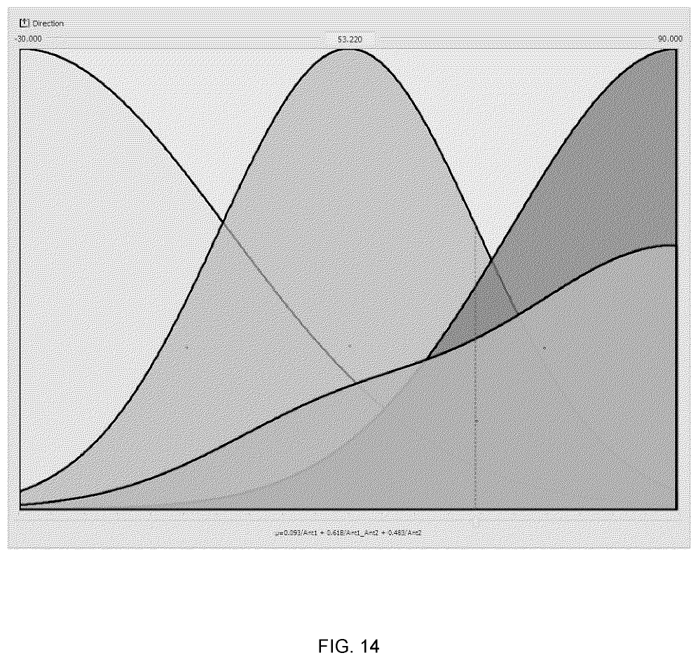

In the example described herein, the output of the first rules is speed. Direction determination will be described with respect to FIGS. 13 and 14. FIG. 13 represents the fuzzy sets associated with the second rules. According to the example, three fuzzy sets are defined for the inputs. The weights corresponding to the fuzzy sets are: small, medium and large. The fuzzy sets have Gaussian distributions for the ΔRSS of the omni-directional antenna 40 and a combination of Gaussian and linear distributions for the ΔRSS of the antenna directions of the multi-directional antenna 30, as shown in FIG. 13.

FIG. 14 represents the fuzzy sets associated with the outputs of the second rules. According to the example, three fuzzy sets are defined for the outputs. The fuzzy sets correspond to: antenna n (Ant_{multi_n}) a midpoint between antenna n and antenna n+1 (Ant_{mid}), and antenna n+1(Ant_{multi_n+1}) The fuzzy sets have Gaussian distributions, as shown in FIG. 13.

Example second rules include:

If ΔRSSₒₘₙᵢ is small and ΔRSS_{multi_n} small and ΔRSS_{multi_n+1} is small then direction is Ant_{mid}.
If ΔRSSₒₘₙᵢ is small and ΔRSS_{multi_n} is small and ΔRSS_{multi_n+1} is medium then direction is Ant_{multi_n+1}.
If ΔRSSₒₘₙᵢ is small and ΔRSS_{multi_n} is small and ΔRSS_{multi_n+1} is large then direction is Ant_{multi_n+1}.
If ΔRSSₒₘₙᵢ is small and ΔRSS_{multi_n} is medium and ΔRSS_{multi_n+1}2 is small then direction is Ant_{multi_n}.
If ΔRSSₒₘₙᵢ is small and ΔRSS_{multi_n} is medium and ΔRSS_{multi_n+1} is medium then direction is Ant_{mid}.
If ΔRSSₒₘₙᵢ is small and ΔRSS_{multi_n} is medium and ΔRSS_{multi_n+1} is large then direction is Ant_{multi_n+1}.
If ΔRSSₒₘₙᵢ is small and ΔRSS_{multi_n} is large and ΔRSS_{multi_n+1} is small then direction is Ant_{multi_n}.
If ΔRSSₒₘₙᵢ is small and ΔRSS_{multi_n} is large and ΔRSS_{multi_n+1} is medium then direction is Ant_{multi_n}.
If ΔRSSₒₘₙᵢ is small and ΔRSS_{multi_n} is large and ΔRSS_{multi_n+1} is large then direction is Ant_{mid}.
If ΔRSSₒₘₙᵢ is medium and ΔRSS_{multi_n} is small and ΔRSS_{multi_n+1} is small then direction is Ant_{mid}.
If ΔRSSₒₘₙᵢ is medium and ΔRSS_{multi_n} is small and ΔRSS_{multi_n+1} is medium then direction is Ant_{multi_n+1}.
If ΔRSSₒₘₙᵢ is medium and ΔRSS_{multi_n} is small and ΔRSS_{multi_n+1} is large then direction is Ant_{multi_n+1}.
If ΔRSSₒₘₙᵢ is medium and ΔRSS_{multi_n} is medium and ΔRSS_{multi_n+1} is small then direction is Ant_{multi_n}.
If ΔRSSₒₘₙᵢ is medium and ΔRSS_{multi_n} is medium and ΔRSS_{multi_n+1} is medium then direction is Ant_{mid}.
If ΔRSSₒₘₙᵢ is medium and ΔRSS_{multi_n} is medium and ΔRSS_{multi_n+1} is large then direction is Ant_{multi_n+1}.
If ΔRSSₒₘₙᵢ is medium and ΔRSS_{multi_n} is large and ΔRSS_{multi_n+1} is small then direction is Ant_{multi_n}.
If ΔRSSₒₘₙᵢ is medium and ΔRSS_{multi_n} is large and ΔRSS_{multi_n+1} is medium then direction is Ant_{multi_n}.
If ΔRSSₒₘₙᵢ is medium and ΔRSS_{multi_n} is large and ΔRSS_{multi_n+1} is large then direction is Ant_{mid}.
If ΔRSSₒₘₙᵢ is large and ΔRSS_{multi_n} is small and ΔRSS_{multi_n+1} is small then direction is Ant_{mid}.
If ΔRSSₒₘₙᵢ is large and ΔRSS_{multi_n} is small and ΔRSS_{multi_n+1} is medium then direction is Ant_{multi_n+1}.
If ΔRSSₒₘₙᵢ is large and ΔRSS_{multi_n} is small and ΔRSS_{multi_n+1} is large then direction is Ant_{multi_n+1}.
If ΔRSSₒₘₙᵢ is large and ΔRSS_{multi_n} is medium and ΔRSS_{multi_n+1} is small then direction is Ant_{multi_n}.
If ΔRSSₒₘₙᵢ is large and ΔRSS_{multi_n} is medium and ΔRSS_{multi_n+1} is medium then direction is Ant_{mid}.
If ΔRSSₒₘₙᵢ is large and ΔRSS_{multi_n} is medium and ΔRSS_{multi_n+1} is large then direction is Ant_{multi_n+1}.
If ΔRSSₒₘₙᵢ is large and ΔRSS_{multi_n} is large and ΔRSS_{multi_n+1} is small then direction is Ant_{multi_n}.
If ΔRSSₒₘₙᵢ is large and ΔRSS_{multi_n} is large and ΔRSS_{multi_n+1} is medium then direction is Ant_{multi_n}.
if ΔRSSₒₘₙᵢ is large and ΔRSS_{multi_n} is large and ΔRSS_{multi_n+1} is large then direction is Ant_{mid}.

As shown the inputs are ΔRSSₒₘₙᵢ=20.100 dB and ΔRSS_{multi_1}=9.200 dB and ΔRSS_{multi_2}=29.750 dB. The output is 53.22 degrees after defuzzification. The angle measurement begins at the start of the scan angle for the first antenna of the adjacent antenna pair. The defuzzification method used is centroid defuzzification, however, other methods of defuzzification, such as centre of mass or majority rule, for example, may alternatively be used. In the example described herein, the output of the first rules is speed and the output of the second rules is direction.

The fuzzy logic method is disclosed by way of example herein. The number of fuzzy sets for the first rules and the second rules is not limited and is determined based on operational specifications. Also, the first rules and second rules may be modified based on different deployment environment or different types of antenna hardware, for example.

When other electronic hub devices 12 having known locations also receive radio beacon signals from the radio beacon 14, the method determines: a change in omni-directional received signal strength and changes in multi-directional received signal strength of the antenna directions for the other electronic hub devices 12. Multi-hub direction information is then determined by combining direction information determined for each electronic hub device 12.

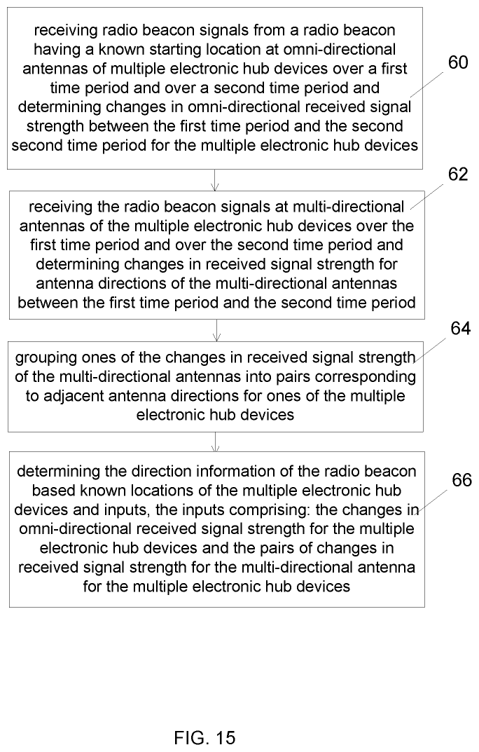

Referring to FIG. 15, another method of tracking a radio beacon 14 is shown. The method of FIG. 15 tracks a radio beacon 14 using multiple electronic hub devices 12, such as two or more electronic hub devices, for example. The method includes: at 60, receiving radio beacon signals from a radio beacon 14 having a known starting location at omni-directional antennas 40 of the multiple electronic hub devices 12 over a first time period and over a second time period and determining changes in omni-directional received signal strength between the first time period and the second time period for the multiple electronic hub devices 12, at 62, receiving the radio beacon signals at multi-directional antennas of the multiple electronic hub devices 12 over the first time period and over the second time period and determining changes in received signal strength for antenna directions of the multi-directional antennas between the first time period and the second time period, at 64, grouping ones of the changes in received signal strength of the multi-directional antennas into groups, such as pairs, for example, corresponding to adjacent antenna directions for ones of the multiple electronic hub devices 12, and at 66, determining the direction information of the radio beacon based on known locations of the multiple electronic hub devices 12 and inputs, the inputs comprising: the changes in omni-directional received signal strength for the multiple electronic hub devices 12 and the pairs of changes in received signal strength for the multi-directional antenna for the multiple electronic hub devices 12.

The method of FIG. 15 is similar to the method of FIG. 6, however, includes one set of inputs: ΔRSSₒₘₙᵢ, ΔRSS_{multi_1} and ΔRSS_{multi_2}, ΔRSS_{multi_2} and ΔRSS_{multi_3}, ΔRSS_{multi_3} and ΔRSS_{multi_4}, ΔRSS_{multi_4} and ΔRSS_{multi_5}, ΔRSS_{multi_5} and ΔRSS_{multi_6}, and ΔRSS_{multi_6} and ΔRSS_{multi_1} for each of the multiple electronic hub devices 12, for example. According to the method of FIG. 15, the direction information is determined by combining possible direction outcomes associated with each of the electronic hub devices 12.

The method of FIG. 15 includes more than one electronic hub device 12. As such, any number of electronic hub devices 12 may be used. As will be understood by persons skilled in the art, the more densely distributed the electronic hub devices 12 are within a deployment environment, the more accurate the direction information determined by the method of FIG. 15. The accuracy may further be improved by receiving radio beacon signals over multiple time periods over a long period of time.

In an example, radio beacon signals received at the omni-directional antenna and the antennas of the first multi-directional antenna are compared in order to reduce noise and signal fading effects. As will be understood by persons skilled in the art, received signal strengths may be averaged over the time periods.

Disclosed herein are methods, apparatus and systems for tracking a radio beacon 14 from a known starting location. The radio beacon 14 may be tracked by one or more electronic hub devices 12 having known locations. The one or more electronic hub devices 12 may have the same antenna array architecture and components. Alternatively, when more than one electronic hub device 12 is used, one of the electronic hub devices 12 may include only one of: an omni-directional antenna 40 and a multi-directional antenna 30, for example.

The radio beacon tracking system 10 is useful for radio beacons 14 that are configurable by the electronic hub devices 12 and for third party devices, such as Smartphones and tablets, for example. The radio beacon tracking system 10 may track third party radio beacons 14 within a coverage area of the radio beacon tracking system 10 and may track movement of third party devices that are passing through the coverage area.

From received signal strengths of radio beacon signals received at the omni-directional and multi-directional antennas 40, 30 of a single electronic hub device 12, over at least two time periods, a direction gradient or a direction of travel of the radio beacon may be determined. Although it may be possible to track a radio beacon 14 using two or more omni-directional antennas 40 or one or more multi-directional antennas 30, by combining the antenna types in an electronic hub device 12 and relying on received signal strength information from both types of antennas, the accuracy of radio beacon tracking may be significantly improved.

Traditionally when determining radio beacon location, omni-directional antennas have been used solely for the purpose of proximity detection. Because they are non-directional, location of a radio beacon 14 with a single omni directional antenna is not possible. At most, a single omni-directional antenna is capable of determining range of a radio beacon 14 with respect thereto. In order to estimate a location of the radio beacon 14 using an omni-directional antenna only, at least three observations from three different electronic hub devices 12 that are not arranged co-linearly are relied upon. In typical electronic hub device 12 deployment environments in which a distance between electronic hub devices 12 is approximately 15-20 meters, such an estimation may only be determined through use of a very complicated estimator. Combining received signal strength information from the different antenna types may simplify radio beacon tracking by taking advantage of sensor array processing, for example.

Another advantage of combining received signal strength information from omni-directional and multi-directional antennas is that the omni-directional antenna may perform more than one role. For example, the radio sub-system 42 of the omni-directional antenna 40 may be capable of switching to a communication mode. When the radio beacon 14 is reliably located within a particular angular range with respect to the electronic hub device 12, input from the antenna directions associated with the angular range may solely be used for tracking.

Specific examples have been shown and described herein. However, modifications and variations may occur to those skilled in the art. All such modifications and variations are believed to be within the scope and sphere of the present disclosure.

1. A method of determining direction information of a radio beacon from a starting location comprising:
receiving radio beacon signals at an omni-directional antenna in communication with a radio sub-system of an electronic hub device over a first time period and over a second time period and determining a change in omni-directional received signal strength between the first time period and the second time period;
receiving the radio beacon signals at a multi-directional antenna in communication with another radio sub-system of the electronic hub device over the first time period and over the second time period, determining changes in received signal strength for antenna directions of the multi-directional antenna between the first time period and the second time period;
grouping ones of the changes in received signal strength of the multi-directional antenna into groups corresponding to adjacent antenna directions;
determining the direction information of the radio beacon based on inputs, the inputs comprising: the change in omni-directional received signal strength and the groups of changes in received signal strength of the multi-directional antenna;
wherein the starting location of the radio beacon and a location of the first electronic hub device are known.

2. The method of claim 1, wherein the direction information comprises one of: a direction gradient and a direction of travel.

3. The method of claim 1, comprising combining at least some of the inputs according to a relationship between the inputs and possible direction outcomes and combining the possible direction outcomes to determine the direction information.

4. The method of claim 3, wherein combining at least some of the inputs according to the relationship between the inputs and possible direction outcomes comprises: assigning weights to the inputs and combining the inputs based on rules to determine the possible direction outcomes.

5. The method of claim 4, wherein the relationship between the inputs and the possible direction outcomes is implemented in fuzzy logic.

6. The method of claim 5, wherein the groups comprise pairs of adjacent antenna directions.

7. The method of claim 6, wherein the adjacent antenna directions are directly adjacent antenna directions.

8. The method of claim 7, wherein the possible direction outcomes comprise: moving toward or away from one of the antenna directions of the electronic hub device, moving toward or away from between one of the adjacent antenna directions of the electronic hub device, moving away from or in front of one of the antenna directions and no change relative to the electronic hub device.

9. The method of claim 7, comprising:
receiving the radio beacon signals at an omni-directional antenna in communication with a radio sub-system of another electronic hub device over the first time period and over the second time period and determining a change in omni-directional received signal strength between the first time period and the second time period;
receiving the radio beacon signals at a multi-directional antenna in communication with another radio sub-system of the other electronic hub device over the first time period and over the second time period, determining changes in received signal strength of antenna directions of the multi-directional antenna between the first time period and the second time period;
grouping the changes in received signal strength of the antenna directions of the multi-directional antenna into pairs corresponding to adjacent antenna directions;
determining the direction information of the radio beacon based on the inputs, the inputs comprising: the change in omni-directional received signal strength and the pairs of changes in received signal strength for the multi-directional antenna for the electronic hub device and the change in omni-directional received signal strength and the pairs of changes in received signal strength for the multi-directional antenna for the other electronic hub device.

10. The method of claim 9, wherein the direction information comprises one of: a direction gradient and a direction of travel.

11. The method of claim 9, wherein the possible direction outcomes comprise: moving toward one or both of the electronic hub device and the other electronic hub device, moving away from one or both of the electronic hub device and the other electronic hub device, moving away from one of the electronic hub device and the other electronic hub device and moving toward the other of the electronic hub device and the other electronic hub device and no change relative to one or both of the electronic hub device and the other electronic hub device.

12. The method of claim 9, comprising comparing radio beacon signals received at the omni-directional antennas and the multi-directional antennas of the electronic hub device and the other electronic hub device to identify noise in the radio beacon signals.

13. The method of claim 9, comprising detecting a change of direction event at a processor in communication with a sensor of the radio beacon and assigning a greater weight to the possible direction outcomes associated with the multi-directional antennas of the electronic hub device and the other electronic hub device than to the possible direction outcomes associated with the omni-directional antennas of the electronic hub device and the other electronic hub device.

14. A method of determining direction information of a radio beacon from a starting location using multiple electronic hub devices comprising:
receiving radio beacon signals at omni-directional antennas of the multiple electronic hub devices over a first time period and over a second time period and determining changes in omni-directional received signal strength between the first time period and the second time period for the multiple electronic hub devices;
receiving the radio beacon signals at multi-directional antennas of the multiple electronic hub devices over the first time period and over the second time period and determining changes in received signal strength for antenna directions of the multi-directional antennas between the first time period and the second time period;
grouping ones of the changes in received signal strength of the multi-directional antennas into groups corresponding to adjacent antenna directions for ones of the multiple electronic hub devices;
determining the direction information of the radio beacon based on inputs, the inputs comprising: the changes in omni-directional received signal strength for the multiple electronic hub devices and the groups of changes in received signal strength for the multi-directional antennas for the multiple electronic hub devices;
wherein the starting location of the radio beacon and locations of the multiple electronic hub devices are known.

15. The method of claim 14, wherein the groups comprise pairs of adjacent antenna directions.

16. The method of claim 15, wherein the adjacent antenna directions comprise directly adjacent antenna directions or approximately adjacent antenna directions.

17. The method of claim 15, wherein the multiple electronic hub devices comprises two electronic hub devices.

18. A beacon tracking system comprising:
a radio beacon movable from a known starting location, the radio beacon generating radio beacon signals;
a first electronic hub device comprising: a first processor and a first radio sub-system in communication with a first omni-directional antenna and a first multi-directional antenna, the first omni-directional antenna receiving the radio beacon signals at a first received signal strength and the first multi-directional antenna receiving the radio beacon signals at first received signal strengths for antenna directions of the multi-directional antennas over a first time period and a second time period, the first electronic hub device comprising a first known location;
a second electronic hub device comprising: a second processor and a second radio sub-system in communication with a second omni-directional antenna and a second multi-directional antenna, the second omni-directional antenna receiving the radio beacon signals at a second received signal strength and the second multi-directional antenna receiving the radio beacon signals at second received signal strengths for the antenna directions of the multi-directional antenna over the first time period and the second time period, the second electronic hub device comprising a second known location;
wherein direction information of the radio beacon is determined based on inputs, the inputs comprising: changes in received signal strength for the first and second omni-directional antennas and changes in received signal strengths for adjacent antenna direction groups for the first and second multi-directional antennas.
